(19) United States
(12) Patent Application Publication
(10) Pub. No.: US 2006/0075975 A1
(43) Pub. Date: Apr. 13, 2006

(54) Animal litter

(76) Inventors: David J. Schneider, Union, KY (US); Charles A. Schneider, Villa Hills, KY (US)

Correspondence Address: Donald R. Bahr, 2608 Merida Lane, Tampa, FL, 33618, US

(21) Appl. No.: 11/243,695

(22) Filed: Oct. 5, 2005

Related U.S. Application Data
(60) Provisional application No. 60/617,129, filed on Oct. 8, 2004.

(51) Int. Cl. A01K 1/015

(52) U.S. Cl. 119/173

(57) ABSTRACT

Animal litters and in particular cat litter are in wide spread use. This invention is concerned with a process whereby the odors which are emitted by used animal litters and in particular cat litter are eliminated or controlled. Odor control in accordance with this invention is effected by the utilization of an animal litter which is treated with a halo sulfonamide compound. In use the halo sulfonamide compound reacts with odorous nitrogen and sulfur bearing compounds which are contained on the litter, as a result of animal waste being positioned on the litter. The halo sulfonamide compound reacts with the nitrogen and sulfur compounds to reduce these compounds to a non odorous format. Wipes for animal litter boxes may further be created by treating textiles with solutions of halo sulfonamide compounds. This invention is particularly effective in controlling odors which originate with used cat litter.

### RELATED APPLICATIONS

This application claims priority of Provisional Application Ser. No. 60/617,129 filed Oct. 6, 2004

### BACKGROUND OF THE INVENTION

This invention is concerned with the control and removal of various odors, which are associated with cats and other animals. An important embodiment of this invention is the control of odors which are associated with cat excrement and urine as may be found in cat litter boxes.

In its broadest sense this invention relates to the use of solutions of halgonated sulfonamide compounds as in situ odor control agents in animal litter, for controlling odors which are associated with animal litter boxes and in particular cat litter. In the prior art, odor control was effected by treating the odorous litter with a perfume. This prior art method for odor control only mask the various complex odor causing molecules. In contrast in this invention these molecules are reacted with a halgonated sulfonamide compound in such a manner that the odorous molecules or destroyed, of altered to a non-odorous format.

### PRIOR ART

Odor control from animal litter boxes in the prior art has been effected by exposing or treating the odorous substrate with a perfume. This perfume mask the troublesome odors but does not alter the odor causing agents on a molecular level. In this invention the odor causing molecules are caused, in situ, to react with a halgonated sulfonamide compound on a molecular level. The reaction in question converts the odorous substances into substances which are non-odorous.

### OBJECTS OF THE INVENTION

An object of this invention is an effective way to control odors which are emitted by animal litter, by utilization of a sulfonamide compound.

Another object of this invention is an improved animal litter.

Still another object of this invention is an improved cat litter.

A further object of this invention is an improved wipe for litter boxes.

### DESCRIPTION OF THE PREFERRED EMBODIMENT

Dogs and cats were domesticated by man and kept as pets, thousands of years ago. Evidence that cats were domesticated has been found in ancient Egyptian tombs.

When animals are kept as pets in close proximity to humans the problem always comes up as to how to contain and handle the animal's body waste. Referring specifically to cats in years past the answer was simple, that is, train the cat to deposit its body waste on used newspaper. While newspaper worked to a degree the general concept left much to be desired. The deposited cat waste on used newspaper was odorous and hence the newspaper, with the waste thereon, had to be disposed of in a short period of time. If the newspaper was not disposed of at least daily, noxious odors soon built up.

In recent years as society became more affluent cat litter was developed and has been put into wide spread usage.

Cat litter is advantageous in that it can be contained in a open box, which boxes are known as litter boxes.

The subject invention is useful in conjunction with any animal waste. Because small animal waste in the form of cat waste is the most common problem this discussion will be directed primary to cat litter.

The use of cat litter extended the time period in which the cat had to be cared for. Cat litter accomplished these ends by allowing the urine and fecal matter to be absorbed and contained by the litter material.

The problem with the prior art cat litter is that, while it absorbed and contained the urine and fecal matter, the prior art cat litter did not mitigate odors which originated with the urine and fecal matter.

In some cases perfumes have been added to cat litter material in order to mask the odors which originate with aging urine and fecal matter, The prior art perfumed cat litter only masked the odor, but did not eliminate the odor. Odors in cat urine and fecal matter essentially result from odorous nitrogen and sulfur bearing compounds.

Most prior art litters are nothing more than an absorbent medium that absorbs urine and the liquid fractions of fecal matter. Even after absorption the urine and fecal matter continue to emit noxious odors.

This invention relates to cat litter which incorporates a substance which reacts, on an in situ basis, with the troublesome odorous nitrogen and sulfur bearing compounds.

In accordance with this invention the cat litter incorporates a N-halogenated sulfonamide aromatic compound or compounds which will react in situ with the troublesome odor causing nitrogen and sulfur bearing compounds.

Most cat litter essentially comprises a particulate absorbent material which is capable of absorbing the liquid components of feline fecal matter and urine. In this invention a compatible N-halogenated sulfonamide aromatic compound is incorporated into the absorbent material in such a manner that it can react with the odorous nitrogen and sulfur bearing compounds which are integral with feline urine and fecal matter.

While any suitable halogenated compound may be utilized as an active reactant for use on cat litter, Chloramine-T has been found to be particularly useful.

The cat litter substrate may be treated with the N-halogenated sulfonamide aromatic compound by treating the substrate with a solution of the desired halogenated sulfonamide compound. The concentration of the N-halogenated sulfonamide aromatic compound, in the treating solution, varies with the particular N-halogenated sulfonamide aromatic compound utilized.

In accordance with another embodiment the litter substrate may be impregnated by tumbled the particulate particles with a dry powdered, N-halogenated sulfonamide aromatic compound.

In addition the N-halogenated sulfonamide aromatic compound may be applied to the litter substrate by any effective method.

Regardless of the mode whereby the litter is impregnated, in a broad sense the concentration of the N-halogenated sulfonamide aromatic compound, applied to the litter substrate, can be from 0.01 to about 5.0 weight percent based on the weight of the cat litter substrate, another range is from about 0.1 to about 1.5 weight percent with still another range being from about 0.2 to about 0.1 weight percent. A useful percentage is 0.5 weight percent.

The litter substrate may further incorporate a buffering agent such as sodium bicarbonate.

When treated with a N-halogenated sulfonamide aromatic compound a resulting litter has a detectable bleach odor. In order to mask this odor the litter may further incorporate trace amounts of a perfume. The litter may further by dyed to any desired color.

Suitable substrates for use in this invention include natural clays in granular form, reconstituted paper, wood chips, particular open cell polymeric materials etc.

Chloramine-T is an example of a suitable N-halogenated sulfonamide aromatic compound which can be used to treat the litter substrate.

Other suitable halogenated compounds which may be used to treat the cat litter substrate in accordance with this invention, are represented by the following formula. 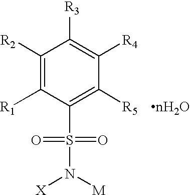
Wherein;
X is a halogen
R1, R2, R3, R4 R5, are hydrogen, COOH, derivatized COOH, an ester or alkylated amide, COOM, CN, NO₂, SO₃H or derivatized SO₃R, a halogen, a substituted or unsubstituted phenyl group, a sulfonamide, a halosulfonamide, a straight or branched aliphatic moiety from C₁ to C₁₂ wherein, the same straight or branched aliphatic moiety may contain substitution at one or more of the aliphatic hydrogens and
M is an alkali or alkaline earth metal.

As to the above set forth compounds it should be noted that the location of the substitution on the aromatic ring can have an affect on the stability and activity of the compound.

The question of stability must be carefully considered by one skilled in the art. That is the selected N-halogonated sulfonamide aromatic compound must be stable in the environment in which it is placed and in particular stable with the substrate. Naturally occurring clays have been found to be useful as litter substrates because of their ability to absorb large volumes of liquids.

The ability of some sulfonamide compounds to react with odorous molecules may be adversely affected by some clay substrates. Accordingly the stability of a particular sulfonamide odor control compound with a substrate medium must be considered in formulating an animal litter.

Further this stability must be considered over a long time frame as animal litters are often stored for extended periods of time, i.e. cat litter being in transit and stored in grocery store for an extended period of time.

Therefore, it is obvious to one skilled in the art that the question of the stability of the sulfonamide compound in the presence of the selected substrate must be carefully considered in the formulation of an animal litter.

Cat litter as described above has been found to be very effective in that the resulting used litter boxes are essentially odor free. Further, these used litter boxes have been found to be “cat friendly” in that cats have been observed returning to the litter box after defecating or urinating. In contrast cats have been observed avoiding untreated used litter boxes.

For use in this invention aqueous solutions of N-halogenated sulfonamide Compounds are preferred however, solutions which are based on other solvents may also be used.

The invention further includes a process for treating an animal litter box which comprises wiping the empty litter box with a porous material which is impregnated with a solution of a N-halogenated sulfonamide aromatic compound.

What is claimed is:

1. An odor control animal litter which comprises a substrate which is treated with an effective amount of an N-halogenated sulfonamide aromatic compound which is compatible with the substrate.

2. The animal litter of claim 1 wherein the substrate is a member selected from the group consisting of a natural clay, reconstituted paper, wood chips and cellular polymeric materials.

3. The animal litter of claim 1, wherein the substrate is a natural clay.

4. The animal litter of claim 1 wherein the N-halogenated, sulfonamide aromatic compound has the following formula; 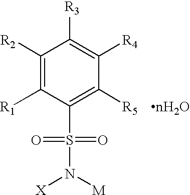
Wherein, X is a halogen,
R1, R2, R3, R4, R5 are hydrogen, COOH, derivatized COOH, an ester or alkylated amide, COOM, CN, NO₂, SO³H or derivatized SO₃R, a halogen, a substituted or unsubstituted phenyl group, a sulfonamide, a halosulfonamide, a straight or branched aliphatic moiety from C₁ to C₁₂ wherein, the same straight or branched aliphatic and
M is an alkali or alkaline earth metal.

5. The animal litter of claim 1 wherein the N-halogenated, sulfonamide compound Is Chloramine-T.

6. The animal litter of claim 1 wherein the substrate contains from about 0.01 to about 5.0 weight percent of the N-halogenated, sulfonamide aromatic compound.

7. The animal litter of claim 2 wherein the substrate contains from about 0.01 to about 5.0 weight percent of the N-halogenated, sulfonamide aromatic compound.

8. The animal litter of claim 3 wherein the substrate contains from about 0.01 to about 5.0 weight percent of the N-halogenated sulfonamide, aromatic compound.

9. The animal litter of claim 4 wherein the substrate contains from about 0.01 to about 5.0 weight percent of the N-halogenated sulfonamide, aromatic compound.

10. The animal litter of claim 5 wherein the substrate contains from about 0.01 to about 5.0 weight percent Chloramine T.

11. The animal litter of claim 6 wherein the substrate contains from about 0.1 to about 1.5 weight percent of the N-halogenated, sulfonamide aromatic compound.

12. The animal litter of claim 7 wherein the substrate contains from about 0.1 to about 1.5 weight percent of the N-halogenated, sulfonamide aromatic compound.

13. The animal litter of claim 8 wherein the substrate contains from about 0.1 to about 1.5 weight percent of the N-halogenated, sulfonamide aromatic compound.

14. The animal litter of claim 9 wherein the substrate contains from about 0.1 to about 1.5 weight percent of the N-halogenated, sulfonamide aromatic compound.

15. The animal litter of claim 10 wherein the substrate contains from about 0.1 to about 1.5 weight percent of the N-halogenated, sulfonamide aromatic compound.

16. The animal litter of claim 6 wherein the substrate contains from about 0.2 to about 1.0 weight percent of the N-halogenated, sulfonamide aromatic compound.

17. The animal litter of claim 7 wherein the substrate contains from about 0.2 to about 1.0 weight percent of the N-halogenated, sulfonamide aromatic compound.

18. The animal litter of claim 8 wherein the substrate contains from about 0.2 to about 1.0 weight percent of the N-halogenated, sulfonamide aromatic compound.

19. The animal litter of claim 9 wherein the substrate contains from about 0.2 to about 1.0 weight percent of the N-halogenated, sulfonamide aromatic compound.

20. A process for treating a used animal litter box which comprises wiping the animal litter box with a porous material which is impregnated with a solution of a N-halogenated sulfonamide aromatic compound.
